(19) United States
(12) Patent Application Publication
(10) Pub. No.: US 2008/0178619 A1
(43) Pub. Date: Jul. 31, 2008

(54) COMBINED MANAGEMENT OF AIR CONDITIONING SYSTEM AND LIGHTING SYSTEM

(75) Inventors: Jin-Seok PARK, Seoul (KR); Sang-Chul YOUN, Seoul (KR); Duck-Gu JEON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 12/013,665

(22) Filed: Jan. 14, 2008

(30) Foreign Application Priority Data
Jan. 26, 2007 (KR) 10-2007-0008561

(51) Int. Cl. F25D 29/00; H05B 37/02

(52) U.S. Cl. 62/161; 315/129

(57) ABSTRACT

A lighting device controller which controls a lighting device and provides a signal to an air conditioner controller indicating an operation state of the lighting device, and an air conditioner controller which receives a signal from a lighting device controller indicating an operation state of a lighting device, and controls an air conditioning unit corresponding to the lighting device in response to the signal are disclosed.

This application claims the benefit of Korean Application No. 10-2007-0008561, filed on Jan. 26, 2007, which is hereby incorporated by reference in its entirety.

### BACKGROUND OF THE INVENTION

1. Field of the Invention

The present invention relates to an air conditioning system and an operation method thereof, and more particularly, to an air conditioning system and an operation method thereof capable of controlling air conditioners in cooperation with the lighting states (operation status) of lighting devices disposed at each area in a building.

2. Background of the Invention

Recently, an air conditioning system and a lighting management system based on a centralized control method are being installed in large-sized buildings to monitor and control air conditioners and lighting devices for each area or location.

However, in the related art, since the air conditioning system and the lighting management system do not cooperate with each other, a user (or operator) cannot simultaneously handle the management of air conditioners and lighting devices located at various locations and areas of a building. Furthermore, the two systems should be operated separately, which is thus inconvenient and costly to implement and maintain.

In addition, a power supply cannot be simultaneously controlled for the lighting devices and air conditioners, which causes inefficient operations and results in undesirable energy loss.

### SUMMARY OF THE INVENTION

One of the features of the present invention is that multiple air conditioners disposed in a building can be controlled by receiving state information of multiple lighting devices disposed in the building from a lighting control system which controls the multiple lighting devices, which thereby enhances user convenience and reduces power consumption.

This feature may be achieved by a lighting device controller which controls a lighting device and provides a signal to an air conditioner controller indicating an operation state of the lighting device.

The lighting device controller centrally controls a plurality of lighting devices in a building, and provides signals to the air conditioner controller indicating operation states of the plurality of lighting devices. The lighting device controller may transmit the signal to the air conditioner controller when the lighting device controller transmits a control signal to the lighting device, or in response to the lighting device controller receiving a signal indicating the operation state of the lighting device. The lighting device controller may receive the signal from a switch connected to the lighting device.

Also disclosed is an air conditioner controller which receives a signal from a lighting device controller indicating an operation state of a lighting device, and controls an air conditioning unit corresponding to the lighting device in response to the signal.

The air conditioner controller receives state information of a plurality of lighting devices in a building. The air conditioning unit may be an outdoor unit, or an indoor unit. At least one indoor unit may be connected to the outdoor unit, and the air conditioner controller may turn off the outdoor unit when each indoor unit connected to the outdoor unit is turned off.

The air conditioner controller turns off the air conditioning unit when the signal indicates that the lighting device is off, and turns on the air conditioning unit when the signal indicates that the lighting device is on.

Also disclosed is a method for controlling an air conditioning system which includes transmitting a signal to an air conditioner controller indicating an operation state of a lighting device, and controlling an air conditioning unit corresponding to the lighting device in response to the signal.

The signal may be transmitted to the air conditioner controller when a lighting device controller transmits a control signal to the lighting device, or in response to a lighting device controller receiving a signal indicating the operation state of the lighting device. The lighting device controller may receive the signal from a switch connected to the lighting device.

Controlling the air conditioning unit may include turning off the air conditioning unit when the signal indicates that the lighting device is off, or turning on the air conditioning unit when the signal indicates that the lighting device is on. The air conditioning unit may be an outdoor unit, or an indoor unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view illustrating an air conditioning system in accordance with a first embodiment of the present invention;

FIG. 2 is a block diagram of the air conditioning system of FIG. 1;

FIG. 3 is a schematic view illustrating an air conditioning system in accordance with a second embodiment of the present invention; and

FIG. 4 is a block diagram of the air conditioning system of FIG. 3.

### DETAILED DESCRIPTION OF THE INVENTION

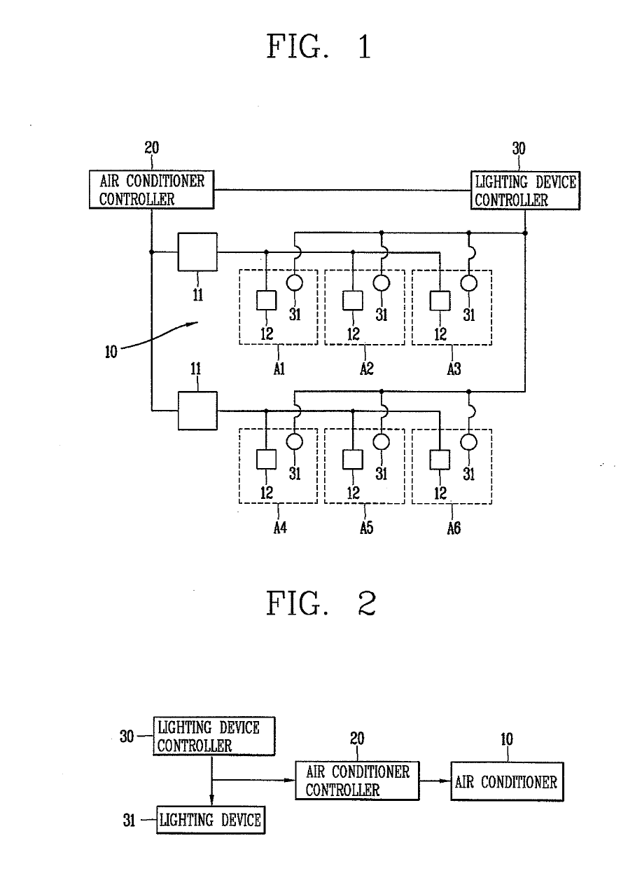

Hereinafter, an air conditioning system and an operation method thereof in accordance with a first embodiment of the present invention will be described with reference to FIGS. 1 and 2.

Illustrated in FIG. 1 is an air conditioning system which comprises an air conditioner 10 having at least one outdoor unit 11 and at least one indoor unit 12 connected to an outdoor unit 11 and disposed at a certain area (e.g., A1, A2, A3, A4, A5 and A6) in a building, an air conditioner controller 20 connected to the air conditioner 10 to control the operations of the outdoor units 11 and/or the indoor units 12, and a lighting device controller 30 connected to at least one lighting device 31 disposed in the building to monitor and control the states of the lighting devices 31.

The air conditioner controller 20 centrally controls the air conditioner 10 by turning on or off a single indoor unit 12 located at a particular area, turning on or off all (or a plurality of) indoor units 12 connected to one outdoor unit 11, or turning on or off the outdoor unit 11.

The lighting device controller 30 centrally controls the lighting devices 31, for example, by turning on or off a single lighting device 31 disposed at a particular area in the building or turning on or off all (or a plurality of) lighting devices 31 located at various areas in the building.

Hereinafter, an operation of the air conditioning system according to the first embodiment of the present invention having such configuration will be described.

As illustrated in FIG. 2, upon receiving a control command from the lighting device controller 30 automatically or manually, a lighting device 31 is turned on or off according to the control command. Also, a signal corresponding to the control command of the lighting device controller 30 is transferred to the air conditioner controller 20. The air conditioner controller 20 controls the operations of the outdoor unit 11 and/or the indoor units 12 in an accordance with the signal corresponding to the control command of the lighting device controller 30.

For example, when a switching signal (which indicates that a lighting device 31 disposed at a particular area A1 in the building should be turned on) is transferred from the lighting device controller 30 to the lighting device 31, the lighting device 31 at the particular area A1 is turned on. At the same time, the air conditioner controller 20 receives a signal from the lighting device controller 30 corresponding to the switching signal, and controls an indoor unit 12 disposed at the particular area A1 and/or an outdoor unit 11 connected to the indoor unit 12 to be turned on, so as to perform an air conditioning operation for the particular area A1.

Also, when a switching signal (which indicates that the lighting device 31 disposed at the particular area A1 in the building should be turned off) is transferred from the lighting device controller 30 to the lighting device 31, the lighting device 31 at the particular area A1 is turned off. At the same time, the air conditioner controller 20 receives a signal from the lighting device controller 30 corresponding to the switching signal, and controls the indoor unit 12 disposed at the particular area A1 and/or the outdoor unit 11 connected to the indoor unit 12 to be turned off.

Here, when the indoor unit 12 is turned off, cooling or heating is stopped for the area where the indoor unit 12 is disposed. Also, when the outdoor unit 11 is turned off, the indoor unit 12 simply operates in a ventilation mode. Therefore, when the lighting device 31 is turned off, the air conditioner controller 20 can control only the indoor unit 12 disposed at the area to be turned off or only the outdoor unit 11 connected to the indoor unit 12 to be turned off.

Here, if a plurality of indoor units 12 connected to one outdoor unit 11 are all turned off, it is preferable to also turn off the outdoor unit 11.

Through the above operations, an outdoor unit 11 and/or indoor units 12 are turned on or off according to the on or off state of a lighting device 31 at a corresponding area in the building. Accordingly, a user does not need to separately handle (operate or manage) the air conditioner 10 and the lighting device 31, which enhances the user's convenience. Also, since an indoor unit 12 disposed at an area in which a lighting device 31 is turned off is automatically turned off, needless power consumption can be reduced.

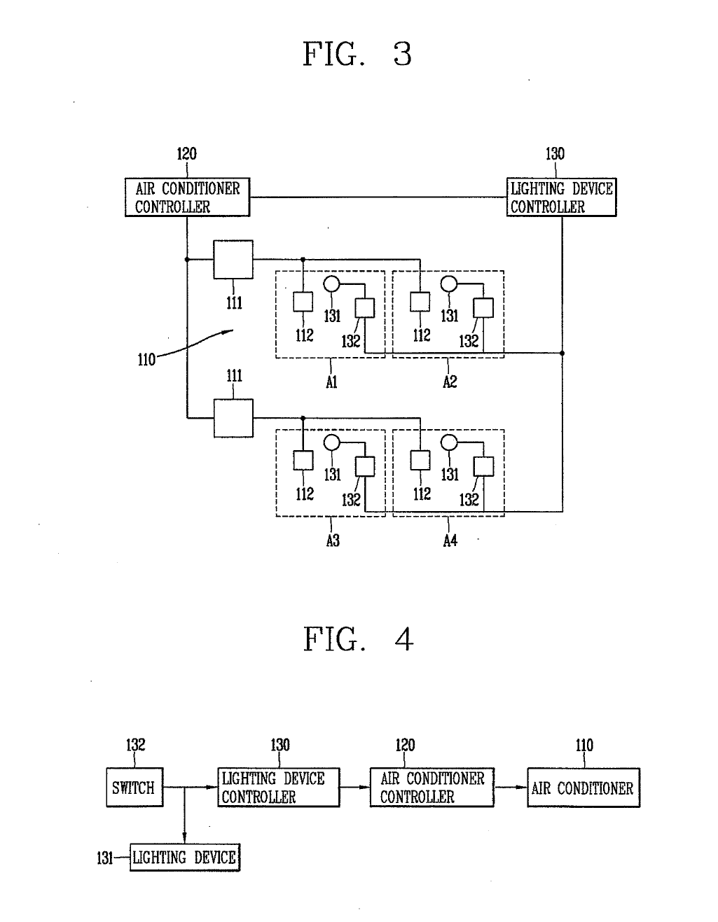

Now, an air conditioning system and an operation method thereof in accordance with a second embodiment of the present invention will be described with reference to FIGS. 3 and 4.

As illustrated in FIG. 3, the air conditioning system according to the second embodiment may comprise an air conditioner 110 having at least one outdoor unit 111 and at least one indoor unit 112 connected to an outdoor unit 111 and disposed at an area (e.g., A1, A2, A3 and A4) in a building, an air conditioner controller 120 connected to the air conditioner 110 for controlling the operations of the outdoor units 111 and/or the indoor units 112, and a lighting device controller 130 connected to at least one lighting device 131 disposed at an area in the building and at least one switch 132 which turns on or off a lighting device 131, for monitoring a state of each of the lighting devices 131.

The air conditioner controller 120 controls the air conditioner 110, for example, by turning on or off an indoor unit 112 disposed at a particular area, turning on or off every (or a plurality of) indoor unit(s) 112 connected to one outdoor unit 111, or turning on or off the outdoor unit 111.

The lighting device controller 130 transfers switching information related to a lighting device 131 disposed at a particular area in the building to the air conditioner controller 120 when the lighting device 131 is turned on or off according to the user's switching operation with the switch 132.

Hereinafter, an operation of the air conditioning system in accordance with the second embodiment of the present invention will be described with reference to FIG. 4.

As illustrated in FIG. 4, when a user located in a particular area in a building turns on or off a lighting device 131 by switching on a switch 132, such state information of the lighting device 131 is transferred to the lighting device controller 130. The lighting device controller 130 then forwards the state information of the lighting device 131 to the air conditioner controller 120. Accordingly, the air conditioner controller 120 transmits a control command to the air conditioner 110 to control an outdoor unit 111 and/or an indoor unit 112.

For example, when a user located in a particular area in the building switches on a switch 132, a lighting device 131 is turned on. At the same time, such switching information of the lighting device 131 is transferred to the lighting device controller 130. The switching information transferred to the lighting device controller 130 is forwarded to the air conditioner controller 120. Accordingly, the air conditioner controller 120 controls (according to the switching information of the lighting device 131) an indoor unit 112 disposed in the particular area and/or an outdoor unit 11 connected to the indoor unit 112 to be turned on, thereby performing an air conditioning operation for the particular area.

In addition, when a user located in a particular area in the building switches off a switch 132, a lighting device 131 is turned off. At the same time, such switching information of the lighting device 131 is transferred to the lighting device controller 130. The switching information transferred to the lighting device controller 130 is forwarded to the air conditioner controller 120. Accordingly, the air conditioner controller 120 controls an indoor unit 112 disposed in the particular area and/or an outdoor unit 11 connected to the indoor unit 112 to be turned off.

Here, when an indoor unit 112 is turned off, cooling or heating is stopped for an area where the indoor unit 112 is disposed. Also, when an outdoor unit 111 is turned off, the indoor unit 112 simply operates in a ventilation mode. Therefore, when a lighting device 131 is turned off, the air conditioner controller 120 can control only an indoor unit 112 disposed at the area to be turned off and/or only an outdoor unit 111 connected to the indoor unit 112 to be turned off.

Through such operations, as the user located in a particular area in a building simply turns on or off a lighting device 131, not only the operation state of the lighting device 131, but also that of the air conditioner 110 can be automatically controlled. Therefore, user convenience can be enhanced and needless power consumption can be reduced.

The air conditioning system according to the present invention can allow air conditioners disposed at each area in a building to be controlled according to the states (or operation status) of lighting devices disposed at each area in the building, so as to improve user convenience and reduce power consumption.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A lighting device controller which controls a lighting device and provides a signal to an air conditioner controller indicating an operation state of the lighting device.

2. The lighting device controller according to claim 1, wherein the lighting device controller centrally controls a plurality of lighting devices in a building, and provides signals to the air conditioner controller indicating operation states of the plurality of lighting devices.

3. The lighting device controller according to claim 1, wherein the lighting device controller transmits the signal to the air conditioner controller when the lighting device controller transmits a control signal to the lighting device.

4. The lighting device controller according to claim 1, wherein the lighting device controller transmits the signal to the air conditioner controller in response to the lighting device controller receiving a signal indicating the operation state of the lighting device.

5. The lighting device controller according to claim 4, wherein the lighting device controller receives the signal from a switch connected to the lighting device.

6. An air conditioner controller which receives a signal from a lighting device controller indicating an operation state of a lighting device, and controls an air conditioning unit corresponding to the lighting device in response to the signal.

7. The air conditioner controller according to claim 6, wherein the air conditioner controller receives state information of a plurality of lighting devices in a building.

8. The air conditioner controller according to claim 6, wherein the air conditioning unit is an outdoor unit.

9. The air conditioner controller according to claim 8, wherein at least one indoor unit is connected to the outdoor unit, and the air conditioner controller turns off the outdoor unit when each indoor unit connected to the outdoor unit is turned off.

10. The air conditioner controller according to claim 6, wherein the air conditioning unit is an indoor unit.

11. The air conditioner controller according to claim 6, wherein the air conditioner controller turns off the air conditioning unit when the signal indicates that the lighting device is off.

12. The air conditioner controller according to claim 6, wherein the air conditioner controller turns on the air conditioning unit when the signal indicates that the lighting device is on.

13. A method for controlling an air conditioning system, comprising:
transmitting a signal to an air conditioner controller indicating an operation state of a lighting device; and
controlling an air conditioning unit corresponding to the lighting device in response to the signal.

14. The method according to claim 13, wherein the signal is transmitted to the air conditioner controller when a lighting device controller transmits a control signal to the lighting device.

15. The method according to claim 13, wherein the signal is transmitted to the air conditioner controller in response to a lighting device controller receiving a signal indicating the operation state of the lighting device.

16. The method according to claim 15, wherein the lighting device controller receives the signal from a switch connected to the lighting device.

17. The method according to claim 13, wherein controlling the air conditioning unit comprising turning off the air conditioning unit when the signal indicates that the lighting device is off.

18. The method according to claim 13, wherein controlling the air conditioning unit comprising turning on the air conditioning unit when the signal indicates that the lighting device is on.

19. The method according to claim 13, wherein the air conditioning unit is an outdoor unit.

20. The method according to claim 13, wherein the air conditioning unit is an indoor unit.
